(19) United States
(12) Patent Application Publication
(10) Pub. No.: US 2005/0270568 A1
(43) Pub. Date: Dec. 8, 2005

(54) Multi-function peripheral

(76) Inventor: Po-Sheng Shih, Hsinchu City (TW)

Correspondence Address: RABIN & Berdo, PC, 1101 14TH STREET, NW, SUITE 500, WASHINGTON, DC, 20005, US

(21) Appl. No.: 11/142,278

(22) Filed: Jun. 2, 2005

(30) Foreign Application Priority Data
Jun. 3, 2004 (TW) 93116034

(51) Int. Cl. G06F 15/00

(52) U.S. Cl. 358/1.15

(57) ABSTRACT

A multi-function peripheral (MFP) includes a scanning unit, a printing unit, a facsimile unit, a network connecting unit, a first control unit and a second control unit. The scanning unit is used to acquire a scan image of a document. The facsimile unit is used to send the scan image or receive a fax image. The network connecting unit is used to transmit the scan image or receive a network image. The printing unit is used to print the scan image, the fax image and the network image. The first control unit is used to control the facsimile unit and the network connecting unit. The second control unit is used to control the scanning and the printing unit, and also communicate with the first control unit.

This application claims the benefit of Taiwan application Serial No. 93116034, filed Jun. 3, 2004, the subject matter of which is incorporated herein by reference.

### BACKGROUND OF THE INVENTION

1. Field of the Invention

The invention is related to a multi-function peripheral (MFP) and more particularly to a multi-function peripheral which is able to be modularized and easy to be functionally upgraded.

2. Description of the Related Art

The multi-function peripheral (MFP), incorporating various functions, such as scanning, printing, facsimile, and copying, offers the convenience of processing data and maximizes the available room space. Therefore, the MFP has gradually become an indispensable data processor in the daily life of the modern society.

Referring to FIG. 1, a schematic diagram of a multi-function peripheral (MFP) is shown. The MFP 10 at least includes a controller 11, a scanning unit 12, a printing unit 13, a facsimile unit 14, a network connecting unit 15 and a computer connecting interface 16. The control unit 11 is used to control the scanning unit 12, the printing unit 13, the facsimile unit 14, and the network connecting unit 15. The scanning unit 12 is used to acquire a scan image of a document. In addition, the facsimile unit 14 connects to a phone line 20 so as to send the scan image or receive a fax image through the phone line 20. The network connecting unit 15 connects to a network 17 and communicates with the first computer 18 through the network 17. The network connecting unit 15 transmits the scan image to the first computer 18 through the network 17 or receives a network image through the network 17 or from the first computer 18. The printing unit 13 is used to scan the scan image, the fax image or the network image. The computer connecting interface 16 is used to connect to a second computer 19 so that the MFP 10 can communicate with the second computer 19.

When the MFP 10 performs different tasks simultaneously, such as scanning documents and receiving facsimile, because all of the scanning unit 12, the printing unit 13, the facsimile unit 14 and the network connecting unit 15 are controlled by the control unit 11, the control unit 11 performs each task with less efficiency than when performing only one task at a time. Consequently, the executions of the tasks drag out for an extended period of time. In addition, once any function of the scanning unit, the facsimile unit, the printing unit, or the network connecting unit of the MFP 10 is to be upgraded, the whole circuit board in the MFP 10 needs to be replaced. In result, additional expense is incurred; and the users are unable to upgrade MFP 10 by themselves at all. Hence, the conventional MFP 10 is inflexible in terms of practicalities.

### SUMMARY OF THE INVENTION

It is therefore an object of the invention to provide a multi-function peripheral of which the scanning unit, the printing unit, the faxing unit and network connecting unit are functionally modularized and being easily upgraded, and a multi-function peripheral able to process several functions simultaneously without any hindrance on operational performance.

It is an object of the present invention to provide a multi-function peripheral (MFP) including a scanning unit, a printing unit, a facsimile unit, a network connecting unit and four control units. The scanning unit is used to acquire a scan image of a document. The facsimile unit is used to send the scan image or receive a fax image. The network connecting unit is used to transmit the scan image or receive a network image. The printing unit is used to print the scan image, the fax image and the network image. Any two of the control units communicate with each other. The four control units control the scanning unit, the facsimile unit, the network connecting unit and the printing unit, respectively.

It is another objective of the present invention to provide a multi-function peripheral (MFP). The MFP includes a scanning unit, a printing unit, a facsimile unit, a network connecting unit, and a first control unit and a second control unit. The scanning unit is used to acquire a scan image of a document. The facsimile unit is used to send the scan image or receive a fax image. The network connecting unit is used to transmit the scanning unit or receive a network image. The printing unit is used to print the scan image, fax image or the network image. The first control unit is used to control the facsimile unit and the network connecting unit. The second control unit is used to communicate with the first control unit and control the scanning unit and the printing unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic drawing of a conventional multi-function peripheral.

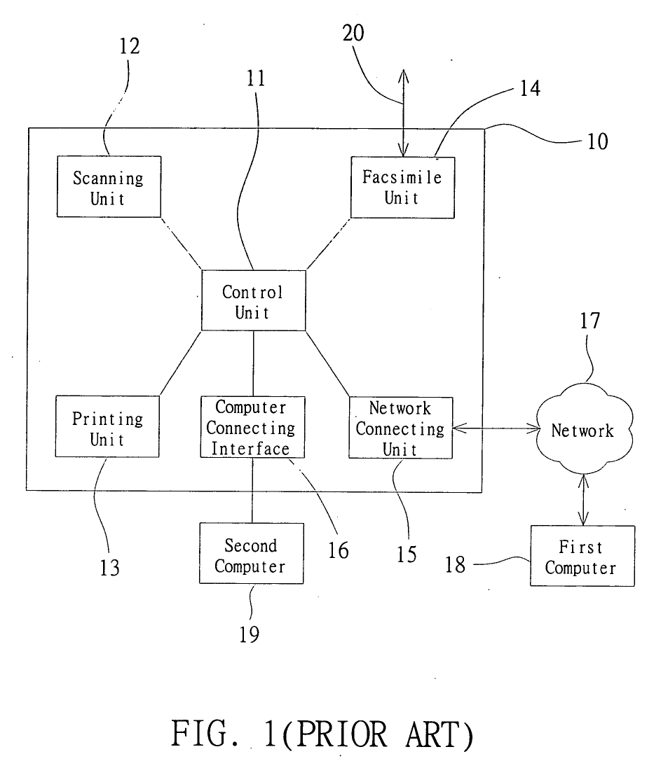

FIG. 2 is a schematic drawing of a multi-function peripheral according to a first embodiment of the present invention.

FIG. 3 is a schematic drawing of a multi-function peripheral according to a second embodiment of the present invention.

### DETAILED DESCRIPTION OF THE INVENTION

### First Embodiment

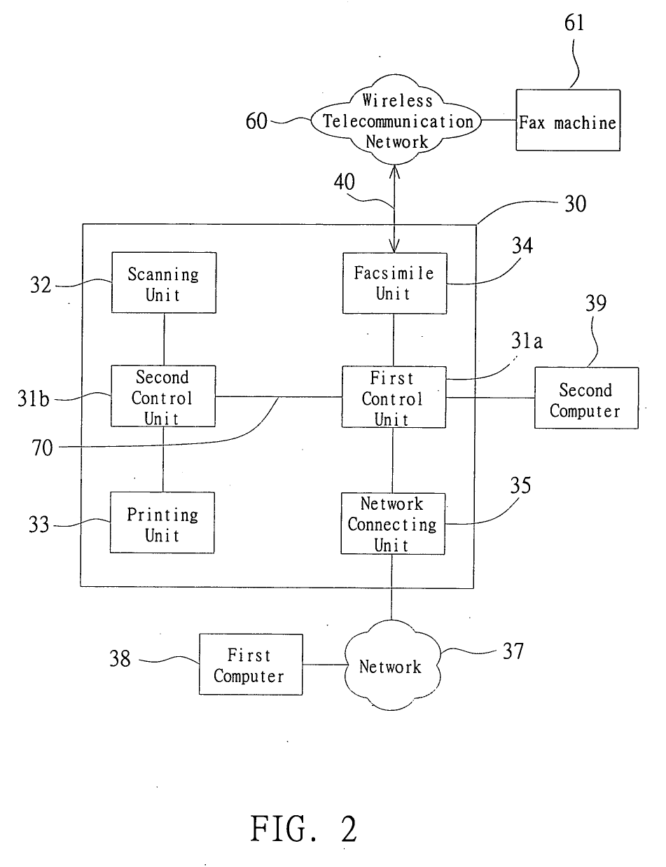

Referring to FIG. 2, the MFP 30 includes the first control unit 31a, the second control unit 31b, the scanning unit 32, the printing unit 33, the facsimile unit 34 and the network connecting unit 35. The first control unit 31a is used to control the facsimile unit 34 and the network connecting unit 35. The second control unit 31b is used to control the scanning unit 32 and printing unit 33. The first control unit 31a is connected to the second control unit 31b through the communication interface 70 so that the first control unit 31a could communicate with the second control unit 31b. The universal serial bus (USB) is an example of the communication interface 70.

The scanning unit 32 is used to acquire a scan image of a document. The facsimile unit 34 connects to a phone line 40 in order to send the scan image or receive a fax image through the phone line 40. The network connecting unit 35 connects to a network 37 and communicates with the first computer 38 through the network 37. The network connecting unit 35 transmits the scan image to the first computer 38 through the network 37 or receives the network image through the network 37 or from the first computer 38. In addition, the printing unit 33 is used to print the scan image, the fax image and the network image.

The first computer 38 could be linked to the multi-function peripheral 30 (MFP) through the network 30. Thus, users can use the first computer 38 to perform various tasks, such as scanning documents, printing files, and faxing files. When the first control unit 31a receives the foregoing commands, the first control unit 31a controls the facsimile unit 40 and the second control unit 31b controls the scanning unit 32 and the printing unit 33, and each respectively executes corresponding actions. Moreover, since the second computer 39 links directly to the MFP 30, the second computer 39 can also command the MFP 30 to perform the functions such as scanning, printing and faxing.

When the multi-function peripheral 30 performs various tasks simultaneously, such as scanning document and receiving fax, the system is designed in such a way that the facsimile unit 34 and the scanning unit 32 are controlled by the first control unit 31a and the second control unit 31b respectively. Therefore, the first control unit 31a and the second control unit 31b will perform corresponding tasks of receiving facsimile and scanning document simultaneously and independently without trade-off. Consequently, the high operational efficiency of the multi-function peripheral 30 could be maintained and the processing delay could be avoided.

Furthermore, the first control unit 31a, facsimile unit 34 and the network connecting unit 35 could be integrated onto the same circuit board. And the second control unit 31b, the electrical components of the scanning unit 32 and the printing unit 33, such as the processor, could be integrated onto another circuit board so that the modularization can be achieved. When any of the various functions of the multi-function peripheral such as scanning or facsimile is to be upgraded, only the circuit board containing the to-be-upgraded elements needs to be replaced with another circuit board having an upgraded component and a first control unit 31 of another design. Thus, a lot of cost will be saved, and also the users can buy the parts of the MFP 30 by themselves to upgrade the operational function of the multi-function peripheral 30 and improve the practicability of the multi-function peripheral 30.

While the invention has been described by way of example and in terms of embodiments, it is to be understood that the invention is not limited thereto. For example, referring to FIG. 2, the facsimile unit 34 is linked to the wireless telecommunication network 60. For this reason, the facsimile unit 34 could fax the scan image to a fax machine 61 by means of wireless faxing through the wireless telecommunication network 60, or could receive the fax image from the fax machine 61 and any fax image through the wireless telecommunication network 60. The network connecting unit 35 can also transmit the scan image to the first computer 38 through the wireless network or receive the network image through the wireless network or from the first computer 38.

### Second Embodiment

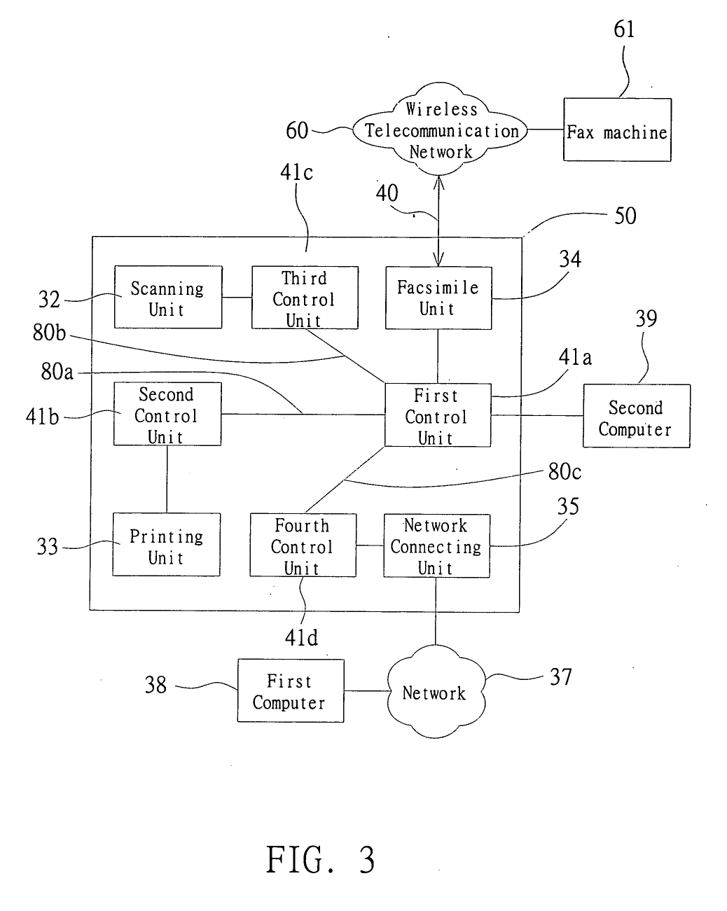

Referring to FIG. 3, the main differences between the MFP 50 of the present embodiment and MFP 30 of the first embodiment are that the MFP 50 control the facsimile unit 34, the printing unit 33, the scanning unit 32 and the network connecting unit 35 via the first control unit 41a, the second control unit 41b, the third control unit 41c and the fourth control unit 41d, respectively. The similarity between the first embodiment and the second embodiment such as similar numbering system will not be repeated. Any two of the first control unit 41a, the second control unit 41b, the third control unit 41c and the fourth control unit 41d communicate with each other through a communication interface. For example, the first control unit 41a communicates with the second control unit 41b and the third control unit 41c and the fourth control unit 41d through the communication interface 80a˜80c, respectively. Accordingly, each function is modularized, and the flexibility of upgrading every individual function independently is increased. In addition, three USB are the examples of the communication interface 80a˜80c.

The first computer 38 can be linked to the MFP 50 through the network 37. Therefore, users can give commands such as scanning, printing, faxing to the MFP50 from the first computer 38. When the fourth control unit 41d receives the foregoing commands, the first control unit 41a, the second control unit 41b, and the third control unit 41c will control the facsimile unit 34, printing unit 33 and the scanning unit 32 respectively in order to perform corresponding actions. Moreover, since the second computer 39 links directly to the MFP 50, the various functions such as scanning, printing and faxing could be performed with commands from the second computer 39. When the first control unit 41a receives the foregoing commands, the first control unit 41a, the second control unit 4 and the third control unit 41c will control the facsimile unit 34, the printing unit 33 and the scanning unit 32 respectively in order to perform corresponding actions.

Furthermore, the first control unit 41a, and the facsimile unit 34 could be integrated onto a circuit board. And the second control unit 41b and the electrical components of the printing unit 33 could be integrated onto a circuit board. The third control unit 41c and the electrical components of the scanning unit 32 could be integrated onto a circuit board and the fourth control unit 41d and the network connecting unit 35 could be integrated onto a circuit board. Accordingly, the objective of modularization can be achieved.

When any of the various functions of the multi-function peripheral 50 is to be upgraded, only the circuit board involving the upgraded elements needs to be replaced.

As described in the embodiments above, the design of the multi-function peripheral of the present invention modularizes various functions, such as scanning, printing, faxing, and copying. It enables the simultaneous processing of various functions without any deficiency in operational performance, and makes independent upgrading of each function easier.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A multi-function peripheral (MFP) comprising:
a scanning unit for acquiring a scan image of a document;
a facsimile unit for sending the scan image or receiving a fax image;
a network connecting unit for transmitting the scan image or receiving a network image;
a printing unit for printing the scan image, the fax image and the network image; and
four control units for controlling the scanning unit, the facsimile unit, the network connecting unit and the printing unit respectively, wherein any two of the four control units communicate with each other.

2. The multi-function peripheral (MFP) as claimed in claim 1, wherein the facsimile unit, connected to a phone line, sends the scan image through the phone line or receives the fax image through the phone line.

3. The multi-function peripheral (MFP) as claimed in claim 1, wherein the facsimile unit connects to a wireless telecommunication network for sending the scan image through the wireless telecommunication network or for receiving the fax image through the wireless telecommunication network.

4. The multi-function peripheral (MFP) as claimed in claim 1, wherein the network connecting unit connects to a network for transmitting the scan image through the network or for receiving the network image through the network.

5. The multi-function peripheral (MFP) as claimed in claim 4 communicating through the network with a computer which outputs the network image to the MFP.

6. The multi-function peripheral (MFP) as claimed in claim 1, wherein any two of the four control units communicate with each other through a communication interface.

7. The multi-function peripheral (MFP) as claimed in claim 6, wherein the communication interface is a universal serial bus (USB).

8. The multi-function peripheral (MFP) as claimed in claim 1 communicating with a computer directly.

9. A multi-function peripheral (MFP) comprising:
a scanning unit for acquiring a scan image of a document;
a facsimile unit for sending the scan image or receiving a fax image;
a network connecting unit for transmitting the scan image or receiving a network image;
a printing unit for printing the scan image, the fax image and the network image;
a first control unit for controlling the facsimile unit and the network connecting unit; and
a second control unit, communicating with the first control unit, for controlling the scanning unit and the printing unit.

10. The multi-function peripheral (MFP) as claimed in claim 9, wherein the facsimile unit, connected to a telephone line, sends the scan image through the telephone line or receives the fax image through the telephone line.

11. The multi-function peripheral (MFP) as claimed in claim 9, wherein the facsimile unit, connected to a wireless telecommunication network, sends the scan image through the wireless telecommunication network or receives the fax image through the wireless telecommunication network.

12. The multi-function peripheral (MFP) as claimed in claim 9, wherein the network connecting unit, connected to a network, transmits the scan image through the network or receives the network image through the network.

13. The multi-function peripheral (MFP) as claimed in claim 12 communicating through the network with a computer which outputs the network image to the MFP.

14. The multi-function peripheral (MFP) as claimed in claim 9, wherein the first control unit communicates with the second control unit through a communication interface.

15. The multi-function peripheral (MFP) as claimed in claim 14, wherein the communication interface is a USB.

16. The multi-function peripheral (MFP) as claimed in claim 9 communicating with a computer directly.
